(19) United States
(12) Patent Application Publication
(10) Pub. No.: US 2013/0013880 A1
(43) Pub. Date: Jan. 10, 2013

(54) STORAGE SYSTEM AND ITS DATA PROCESSING METHOD

(75) Inventors: Naomitsu Tashiro, Oi-machi (JP); Taizo Hori, Hadano (JP); Motoaki Iwasaki, Hiratsuka (JP)

(73) Assignees: HITACHI COMPUTER PERIPHERALS CO., LTD.; HITACHI, LTD.

(21) Appl. No.: 13/145,469

(22) PCT Filed: Jul. 8, 2011
(86) PCT No.: PCT/JP2011/003928

§ 371 Date: Jul. 20, 2011

(51) Int. Cl. G06F 12/02

(52) U.S. Cl. 711/170; 711/E12.005

(57) ABSTRACT

The de-duplication effect is enhanced even when managing data blocks by dividing them into fixed-length data.

Every time a data block is entered, a controller for managing data blocks: sequentially sets a search area of a fixed size from a top of each data block to an end thereof; calculates a first hash value of data belonging to each search area; allocates a search area(s), for which the first hash value becomes a first set value, to a first chunk from among each of the search areas; allocates a search area(s), for which the first hash value is a minimum value, to a second chunk from among the search areas existing in an area larger than the search area if the area larger than the search area exists in an area other than the area to which the first chunk is allocated; allocates an area(s) smaller than the search area to a third chunk; calculates a second hash value from data of each chunk; and manages chunks having the same second hash value, as de-duplication chunks.

### TECHNICAL FIELD

The present invention relates to a storage system and its data processing method.

### BACKGROUND ART

Conventionally, there is a storage system equipped with storage devices having a plurality of storage units, and a controller for controlling data input to, or output from, the storage devices based on access requests from a client terminal.

With this type of storage system, a plurality of pieces of data are stored in each data block, where the data are arrayed, in the storage devices. There is a suggested technique for storing data as described above by repeating processing for: sequentially setting a window of a fixed size, for example, from the top of each data block; calculating a hash value of data in each window; and, if the calculated hash value corresponds to a previously set value V, dividing the data block into subblocks at that position; and, if the calculated hash value does not correspond to the set value V, shifting the window by 1 byte until the hash value in the window corresponds to the set value V (see Patent Literature 1).

Patent Literature 1 discloses that when managing a plurality of data blocks, a data block of each generation is divided into a plurality of subblocks, a hash value is calculated from data of each subblock, the hash values of the subblocks of each generation are compared, and the subblocks having the same hash value are managed as subblocks for de-duplication.

### CITATION LIST

### Patent Literature

PTL 1: U.S. Pat. No. 5,990,810

### SUMMARY OF INVENTION

### Technical Problem

According to the conventional technology, the processing for shifting the window by 1 byte until the hash value of data in the window corresponds to the set value V. So, the data size of each subblock created by dividing data blocks is a variable length and the subblocks are of different data sizes. Consequently, the probability of obtaining the same hash value from data of each subblock is low and the de-duplication effect will be reduced even if each subblock is managed by using the hash values.

Furthermore, when using storage media for storing data in fixed-length data blocks is considered, data blocks for variable-length data cannot be stored efficiently in the storage media.

The present invention was devised in light of the problems of the above-described conventional technology and it is an object of the invention to provide a storage system and its data processing method capable of enhancing the de-duplication effect even when managing data blocks by dividing them into fixed-length data.

### Solution to Problem

In order to achieve the above-described object, a storage system according to the present invention is configured so that in a process of sequentially processing data blocks composed of a plurality of pieces of data, a controller for controlling data input to, or output from, storage devices based on an access request from an access requestor: sequentially sets a search area of a fixed size from a top of each data block to an end thereof; calculates a first hash value of each search area from data of each set search area; divides an area of each data block into a plurality of areas on the basis of the calculated first hash value; allocates each of the divided areas to a chunk of a fixed size; calculate a second hash value of the chunk from data of each chunk; and manages each chunk allocated to each data block on the basis of the calculated second hash value. When this happens, the controller compares the second hash value of each allocated chunk between each data block; and if the chunks having the same second hash value are allocated to each data block, the controller manages the chunks having the second hash value, from among the chunks allocated to each data block, as de-duplication chunks.

### Advantageous Effects of Invention

The de-duplication effect can be enhanced according to the present invention even when managing data blocks by dividing them into fixed-length data.

### BRIEF DESCRIPTION OF DRAWINGS

FIG. 1 is a block diagram explaining the overview of the invention.

FIG. 2 is a characteristic diagram explaining the relationship between hash values for low-order M bits and offsets.

FIG. 3 is a configuration diagram showing data blocks of a plurality of generations.

FIG. 4 is a configuration diagram of a management table for managing data of data blocks of a plurality of generations.

FIG. 5 is a block diagram of a computer system according to a first embodiment of the present invention.

FIG. 6 is a configuration diagram of virtual volume information.

FIG. 7 is a configuration diagram of data block storage information.

FIG. 8 is a configuration diagram of chunk index information.

FIG. 9 is a flowchart explaining the content of data division processing.

FIG. 10 is a flowchart explaining the content of concatenated chunk creation processing.

FIG. 11 is a flowchart explaining the content of de-duplication processing.

FIG. 12 is a block diagram of a computer system according to a second embodiment of the present invention.

### DESCRIPTION OF EMBODIMENTS

Overview of the Invention

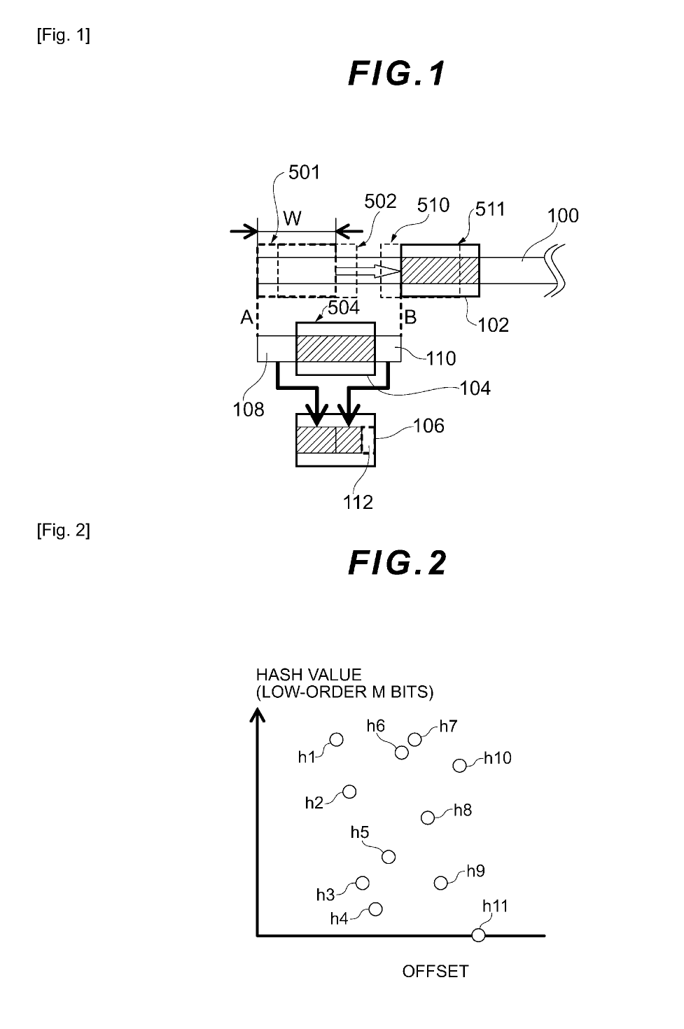

Next, the overview of the invention will be explained with reference to FIG. 1.

Referring to FIG. 1, when managing a data block 100 composed of a plurality of pieces of data, for example, a controller (not shown) for managing the data block 100 sets a window 501 of a fixed size, for example, W bytes (W is a positive integer) from the top of the data block 100.

When this happens, the window which is a search area of the fixed size is sequentially set from the top of the data block 100 to the end thereof. When the window 501 is set to the data block 100, data (fixed-length data) in the window 501 is applied to a hash function f(x) and a hash value is calculated by using the hash function f(x).

If a value represented by low-order M bits (M is a positive integer) of the calculated hash value does not correspond to a first set value, for example, 0, the window 501 is shifted from the top A towards the end by 1 byte; a new window 502 of the fixed size (W bytes) is set; data (fixed-length data) in the window 502 is applied to a hash function f(x) and a hash value is calculated by using the hash function f(x); and if a value represented by the low-order M bits of the calculated hash value does not correspond to 0, data (fixed-length data) in a newly set window is applied to the hash function f(x) and a hash value is calculated by using the hash function f(x) and repeats processing for shifting the window of the fixed size (W bytes) towards the end of the data block 100 by 1 byte until a value represented by the low-order M bits of the calculated hash value corresponds to 0.

On the other hand, if the value represented by the low-order M bits of the calculated hash value (M is a positive integer) corresponds to 0, for example, if the value represented by the low-order M bits of the hash value obtained from the data (fixed-length data) in a window 511 corresponds to 0, the entire window 511 is allocated to a first chunk 102.

For example, as shown in FIG. 2, if values represented by the low-order M bits of the hash values obtained from data (fixed-length data) in the first set window 501 to the 11^{th} set window 511 are h1 to h11, respectively, the values represented by the low-order M bits of the hash values obtained from the data in the windows 501 to 510 do not correspond to 0 in the process of sequentially setting the first window 501 to the 10^{th} window 510 to the data block 100, so that the windows 501 to 510 are shifted by 1 byte.

On the other hand, since the value represented by the low-order M bits of the hash value obtained from the data in the 11^{th} window 511 is h11 and corresponds to 0, the entire window 511 is allocated as the first chunk 102.

Next, if an area of W bytes or more exists in an area between the top A of the data block 100 and position B immediately before the first chunk 102 after the first chunk 102 is allocated to an area corresponding to the window 511 in the data block 100, the entire window, for which the value represented by the low-order M bits of the hash value indicates a second set value, for example, a minimum value, is allocated as a second chunk.

For example, if the windows 501 to 510, for which the values represented by the low-order M bits of the hash values are h1 to h10, respectively, exist as an area of W bytes or more between the top A of the data block 100 and the position B immediately before the first chunk 102, the window 504 corresponding to the hash value h4, for which the value represented by the low-order M bits of the hash value is a minimum value, is allocated as a second chunk 104.

Then, the processing for allocating the second chunk 104 is repeated until there is no area of W bytes or more left between the top A of the data block 100 and the position B immediately before the first chunk 102.

Subsequently, if the area of W bytes or more no longer exists, but an area less than W bytes exists in the area between the top A of the data block 100 and the position B immediately before the first chunk 102, for example, if areas 108, 110 exist, a concatenated chunk 106 is created as a third chunk and data existing in the areas less than W bytes 108, 110 are allocated to the concatenated chunk 106.

If an unused area 112 exists in the concatenated chunk 106 under the above-described circumstance, padding data for filling the unused area 112, for example, data 0 (data 0 of digital data 1 and 0) is embedded to configure the concatenated chunk 106.

The above-described processing is executed from the top A of the data block 100 to the end thereof and one or more sets of the first chunk 102, the second chunk 104, and the concatenated chunk 106 are allocated to the data block 100. Accordingly, the area of the data block 100 is divided by the first chunk 102, the second chunk 104, and the concatenated chunk 106 into a plurality of areas.

After dividing the data block 100 by each chunk, data (fixed-length data) of each chunk is applied to a hash function g(x) and a hash value of each chunk is calculated by using the hash function g(x); and each chunk is managed based on each calculated hash value.

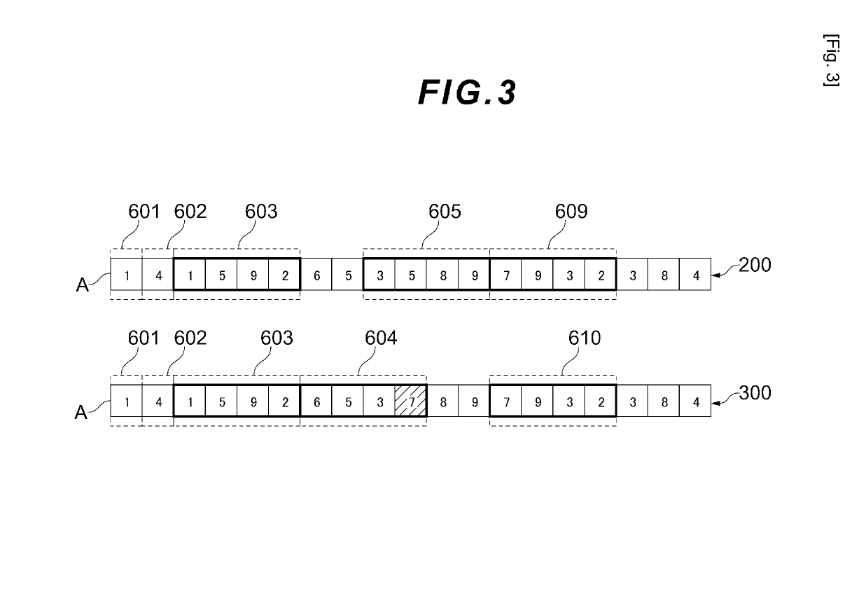

Now, when managing data blocks of a plurality of generations, for example, when managing a data block 200 of a first generation and a data block 300 of a second generation as shown in FIG. 3, each data block 200, 300 is divided into the first chunk, the second chunk, or the concatenated chunk, a hash value is calculated from data of each chunk obtained by division, and each chunk is managed based on the calculated hash value.

For example, if the data block 200 of the first generation and the data block 300 of the second generation are configured by arranging a plurality of pieces of 1-byte data 1 to 9, a 4-byte window 601 is set as a window of a fixed size from the top A of the data block 200, data in the window 601 is applied to the hash function f(x) and a hash value is calculated by using the hash function f(x); and if a value represented by low-order 2 bits of the calculated hash value is 0, the entire window 601 is allocated to the first chunk.

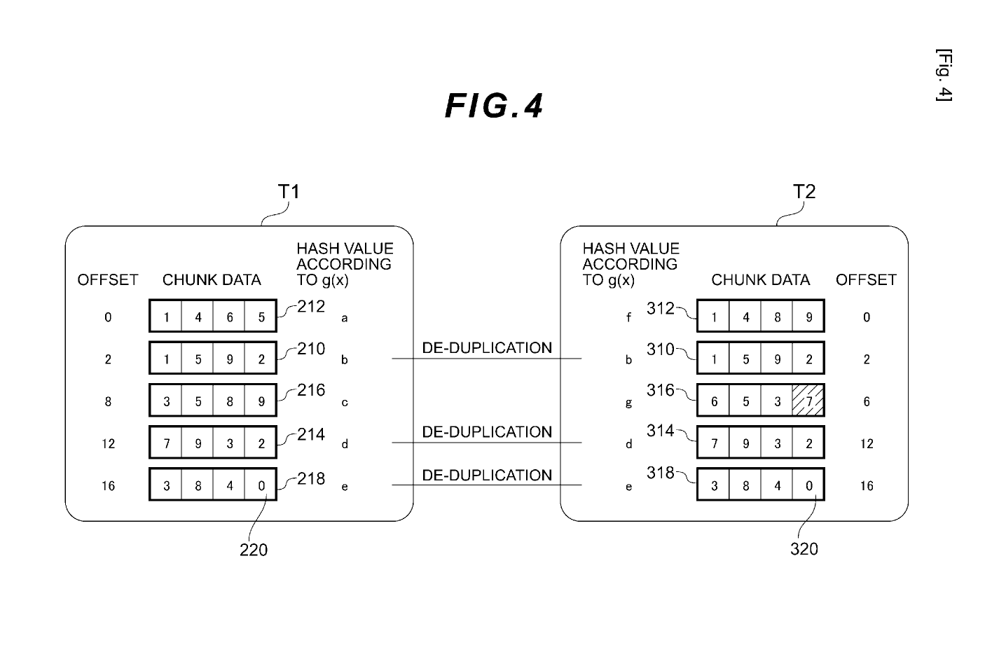

If in the process of sequentially setting 4-byte windows from the top A of the data block 200, applying data in each window to the hash function f(x), and calculating a hash value of each window by using the hash function f(x) under the above-described circumstance, a value represented by the low-order 2 bits of the hash values obtained from data in the first window 601 and data in a second window 602 are not 0, respectively, but a value represented by the low-order 2 bits of the hash value obtained from data in a third window 603 is 0, the entire third window 603 is allocated as a first chunk 210; and the first chunk 210 is registered in a management table T1 as shown in FIG. 4.

In this case, the first chunk 210 is configured by arranging 4 pieces of 1-byte data 1, 5, 9, 2. Furthermore, since the data 1 at the top of the first chunk 210 is located at a second position from the top A of the data block 100, 2 is recorded as offset in the management table T1.

Furthermore, since an area existing between the top A of the data block 100 and the position B immediately before the first chunk 210 is smaller than any of the windows 601 to 603, data 1 and 4 existing in this area are allocated to the concatenated chunk 212.

Subsequently, if a 9^{th} window 609 is found as a window, for which a value represented by the low-order 2 bits of the hash value is 0, in the process of sequentially setting the 4-byte windows to the data block 200 and calculating each hash value from data in each set window, the entire window 609 is allocated to a first chunk 214; and the first chunk 214 is registered in the management table T1.

In this case, an area larger than the window 609 exists in an area between the top A of the data block 100 and the position B immediately before the first chunk 214. So, the entire window, for example, the entire 5^{th} window 605, for which a value represented by the low-order 2 bits of the hash value is a minimum value, from among the windows set in this area, is allocated to a second chunk 216; and the second chunk 216 is registered in the management table T1.

When this happens, an area composed of data 6 and 5 exists in an area between the top A of the data block 100 and position B immediately before the second chunk 216, so that the data 6 and 5 existing in this area are allocated to a concatenated chunk 212.

Furthermore, if an area smaller than the window, for example, an area, which is composed of data 3, 8, 4, after setting a window 609 exists in the process of sequentially allocating windows from the top A of the data block 100 to the end thereof, the data 3, 8, 4 existing in this area are allocated to a concatenated chunk 218.

Since an unused area exists in the concatenated chunk 218 in this case, data 0 220 as padding data for filling the unused area is embedded in the concatenated chunk 218, thereby configuring the concatenated chunk 218.

Regarding each chunk 210 to 218, offset which indicates the position of the relevant chunk relative to the top A of the data block 200 is registered in the management table T1; and data in each chunk 210 to 218 is applied to the hash function g(x), the hash value of each chunk 210 to 218 is calculated by using the hash function g(x), and each calculated hash value is recorded in the table T1.

For example, if “a,” “b,” “c,” “d,” “e” are obtained by calculation as hash values of the concatenated chunk 212, the first chunk 210, the second chunk 216, the first chunk 214, and the concatenated chunk 218, respectively, these hash values are recorded in the management table T1.

Next, the processing for dividing a data block into a plurality of chunks is also executed on the data block 300 of the second generation.

Firstly, the 4-byte window 601 as a window of a fixed size is set from the top A of the data block 300, data in the window 601 is applied to the hash function f(x), and a hash value is calculated by using the hash function f(x); and if a value represented by the low-order 2 bits of the calculated hash value is 0, the entire window 601 is allocated to the first chunk.

If in the process of sequentially setting the 4-byte windows from the top A of the data block 300, applying data in each window to the hash function f(x), and calculating the hash value of each window by using the hash function f(x), values represented by the low-order 2 bits of the hash values obtained from data in the first window 601 and data in the second window 602 are not 0, respectively, but a value represented by the low-order 2 bits of the hash value obtained from data in the third window 603 is 0, the entire third window 603 is allocated as a first chunk 310 and the first chunk 310 is registered in a management table T2 as shown in FIG. 4.

In this case, the first chunk 310 is configured by arranging four pieces of 1-byte data 1, 5, 9, 2. Furthermore, the data 1 at the top of the first chunk 310 is located at the second position from the top A of the data block 300, so 2 is recorded as offset in the management table T2.

Furthermore, since an area existing between the top A of the data block 300 and position B immediately before the first chunk 310 is smaller than any of the windows 601 to 603, data 1 and 4 existing in this area are allocated to a concatenated chunk 312.

Subsequently, if a 10th window 610 is found as a window, for which a value represented by the low-order 2 bits of the hash value is 0, in the process of sequentially setting the 4-byte windows to the data block 300 and calculating each hash value from data in each window, the entire window 610 is allocated to a first chunk 314; and the first chunk 314 is registered in the management table T2.

In this case, an area larger than the window 610 exists in an area between the top A of the data block 300 and position B immediately before the first chunk 314. So, the entire window, for example, the entire 4^{th} window 604, for which a value represented by the low-order 2 bits of the calculated hash value is a minimum value, from among the windows set in this area, is allocated to a second chunk 316; and the second chunk 316 is registered in the management table T2.

When this happens, an area composed of data 8 and 9 exists in an area between the top A of the data block 300 and position B immediately before the second chunk 316, so that the data 8 and 9 existing in this area are allocated to a concatenated chunk 312.

Furthermore, if an area smaller than the 4-byte window, for example, an area, which is composed of data 3, 8, 4, after setting a window 610 exists in the process of sequentially allocating the 4-byte windows from the top A of the data block 300 to the end thereof, the data 3, 8, 4 existing in this area are allocated to a concatenated chunk 318.

Since an unused area exists in the concatenated chunk 318 in this case, data 0 220 as padding data for filling the unused area is embedded in the concatenated chunk 318, thereby configuring the concatenated chunk 318.

Regarding each chunk 310 to 318, offset which represents the position of the relevant chunk relative to the top A of the data block 300 is registered in the management table T2; and data in each chunk 310 to 318 is applied to the hash function g(x), the hash value of each chunk 310 to 318 is calculated by using the hash function g(x), and each calculated hash value is recorded in the table T2.

For example, if “f,” “b,” “g,” “d,” “e” are obtained by calculation as hash values of the concatenated chunk 312, the first chunk 310, the second chunk 316, the first chunk 314, and the concatenated chunk 318, respectively, these hash values are recorded in the management table T2.

When storing each chunk of the data block 200 in the storage device (not shown) and then storing each chunk of the data block 300 in the storage device, the hash values of the respective chunks of the data block 200 are compared with the hash values of the respective chunks of the data block 300 and the chunks corresponding to the same hash value are managed as de-duplication targets.

For example, the hash values (“b,” “d,” “e”) relating to the first chunks 310, 314 and the concatenated chunk 318 of the data block 300 are the same as the hash values (“b,” “d,” “e”) relating to the first chunks 210, 214 and the concatenated chunk 218 of the data block 200, so that the first chunks 310, 314, and the concatenated chunk 318 are managed as the de-duplication targets.

Specifically speaking, the first chunks 310, 314 and the concatenated chunk 318 of the data block 300 are not stored in the storage device and the second chunk 316 and the concatenated chunk 312 are recorded, as update target chunks, in the storage device.

As a result, when managing the data blocks 200, 300, the de-duplication effect can be enhanced even if the data blocks 200, 300 are divided by the fixed size (4 bytes) windows into a plurality of chunks and each chunk obtained by this division is managed by using the hash value (second hash value) obtained from data of each chunk which is fixed-length data.

### Embodiments

Overall Configuration

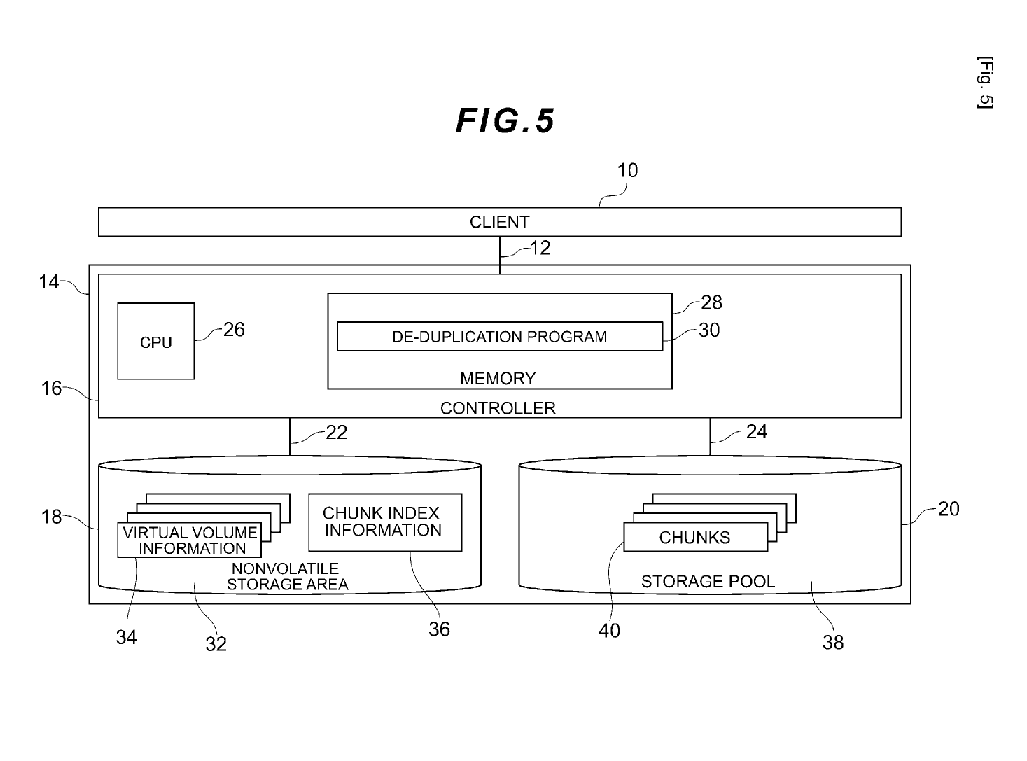

Next, FIG. 5 shows a block diagram of a computer system to which the present invention is applied. Referring to FIG. 5, the computer system includes a client terminal (hereinafter sometimes referred to as the client) 10, a network 12, and a storage system 14.

The client 10 is, for example, a computer device equipped with information processing resources such as a CPU (Central Processing Unit), a memory, and an input/output interface. The client 10 can access logical volumes provided by the storage system 14 by sending an access request designating the logical volumes, for example, a write request or a read request to the storage system 14.

The network 12 can be, for example, FC SAN (Fibre Channel Storage Area Network), IP SAN (Internet Protocol Storage Area Network), LAN (Local Area Network), or WAN (Wide Area Network).

The storage system 14 is constituted from a controller 16, a storage device 18, and a storage device 20; and the controller 16 is connected via internal networks 22, 24 to the storage devices 18, 20.

The controller 16 is constituted from a CPU 26 for supervising and controlling the entire controller 16, and a memory 28. The memory 28 stores various programs such as a de-duplication program 30 for executing chunk de-duplication processing.

The storage device 18 has a nonvolatile storage area 32; and the nonvolatile storage area 32 stores a plurality of pieces of virtual volume information 34 and chunk index information 36. Incidentally, the nonvolatile storage area 32 can be stored in the memory 28.

The storage device 20 is composed of a plurality of storage units such as HDDs (Hard Disk Drives). A storage pool 38 is configured and a chunk storage area 40 for storing chunks are formed in the storage area composed of one or more storage units.

If HDDs are used as the storage units, for example, FC (Fibre Channel) disks, SCSI (Small Computer System Interface) disks, SATA (Serial ATA) disks, ATA (AT Attachment) disks, or SAS (Serial Attached SCSI) disks can be used.

Besides HDDs, for example, semiconductor memory devices, optical disk devices, magneto-optical disk devices, magnetic tape devices, and flexible disk devices can be used as the storage units.

If semiconductor memory devices are used as the storage units, for example, SSD (Solid State Drive) (flash memory), FeRAM (Ferroelectric Random Access Memory), MRAM (Magnetoresistive Random Access Memory), phase change memory (Ovonic Unified Memory), or RRAM (Resistance Random Access Memory) can be used.

Furthermore, each storage unit can constitute a RAID (Redundant Array of Inexpensive Disks) group such as RAID4, RAID5, or RAID6 and each storage unit can be divided into a plurality of RAID groups. Under this circumstance, one or more virtual volumes or one or more logical volumes can be formed in a physical storage area of each storage unit.

The virtual volumes are virtual logical volumes provided, as access targets of the client 10, to the client 10.

The virtual volumes are composed of virtual areas to which real areas (for example, data blocks) are allocated from a capacity pool by, for example, a thin provisioning function. At a stage before write access is made to a virtual volume, a real area is not allocated to a virtual area. On the other hand, if write access is made to the virtual volume, the real area is allocated to the virtual area and data is stored in the allocated real area.

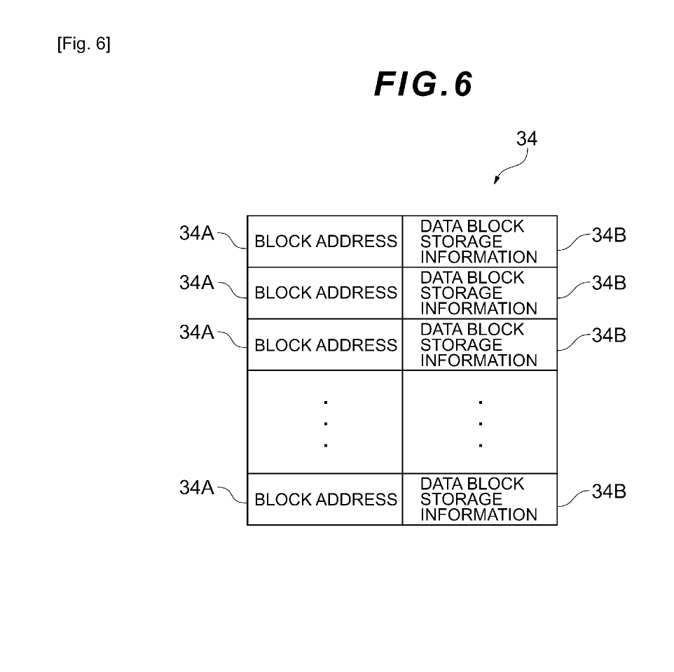

Next, FIG. 6 shows a configuration diagram of virtual volume information.

Referring to FIG. 6, the virtual volume information 34 is information for managing storage locations of data blocks allocated to each virtual volume wherein one piece of such information exists for each virtual volume; and is constituted from a plurality of data block addresses 34A and a plurality of pieces of data block storage information 34B

Each block address 34A is a top block address of each data block allocated to the relevant virtual volume. Incidentally, if each data block has a fixed length, the block address 34A can be omitted.

Each piece of data block storage information 34B is information indicating the actual storage location of each data block allocated to the relevant virtual volume.

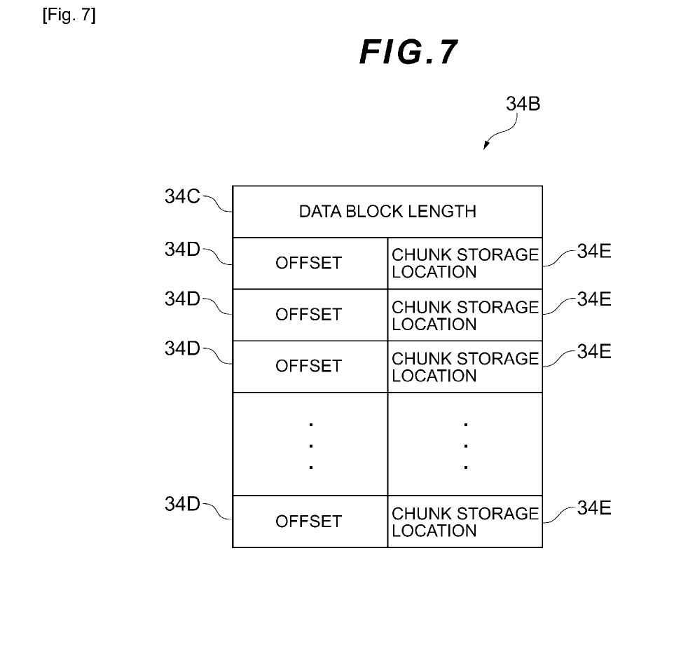

Next, FIG. 7 shows a configuration diagram of the data block storage information.

The data block storage information 34B is information for managing storage locations of chunks allocated to each data block wherein one piece of such information exists for each data block. The data blocks constitute files, LUs, and virtual volumes. The data block storage information 34B is constituted from a data block length 34C, a plurality of offsets 34D, and a plurality of chunk storage locations 34E corresponding to the respective offsets 34D. The data block length 34C is information indicating the length of the relevant data block. Incidentally, if the data block has a fixed length, the data block length 34C can be omitted.

Each offset 34D is information indicating the position of each chunk relative to the top of the relevant data block.

Each chunk storage location 34E is information indicating the storage location of each chunk. Each chunk storage location 34E stores, for example, a file name and/or a block address as information indicating the actual storage location of each chunk.

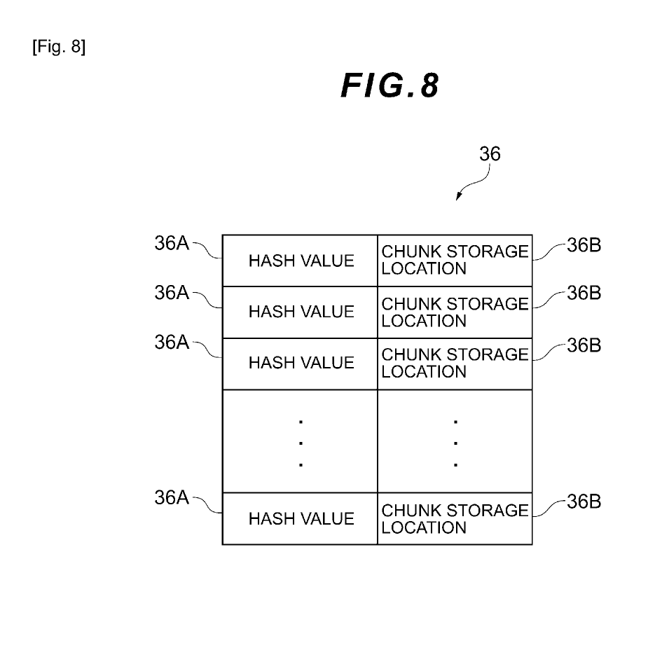

Next, FIG. 8 shows a configuration diagram of chunk index information.

Chunk index information 36 is information for managing storage locations of a plurality of chunks and hash values of the plurality of chunks, wherein one piece of such information exists in the storage system 14. The chunk index information 36 is constituted from a plurality of hash values 36A and a plurality of chunk storage locations 36B.

Each hash value 36A is a hash value which is obtained by using the hash function g(x) used for the de-duplication processing and is obtained from data of the entire chunk or data of part of the chunk.

Each chunk storage location 36B is information for identifying the actual storage location of each chunk, for example, a chunk storage area 40. Each chunk storage location 36B stores, for example, a file name and/or a block address.

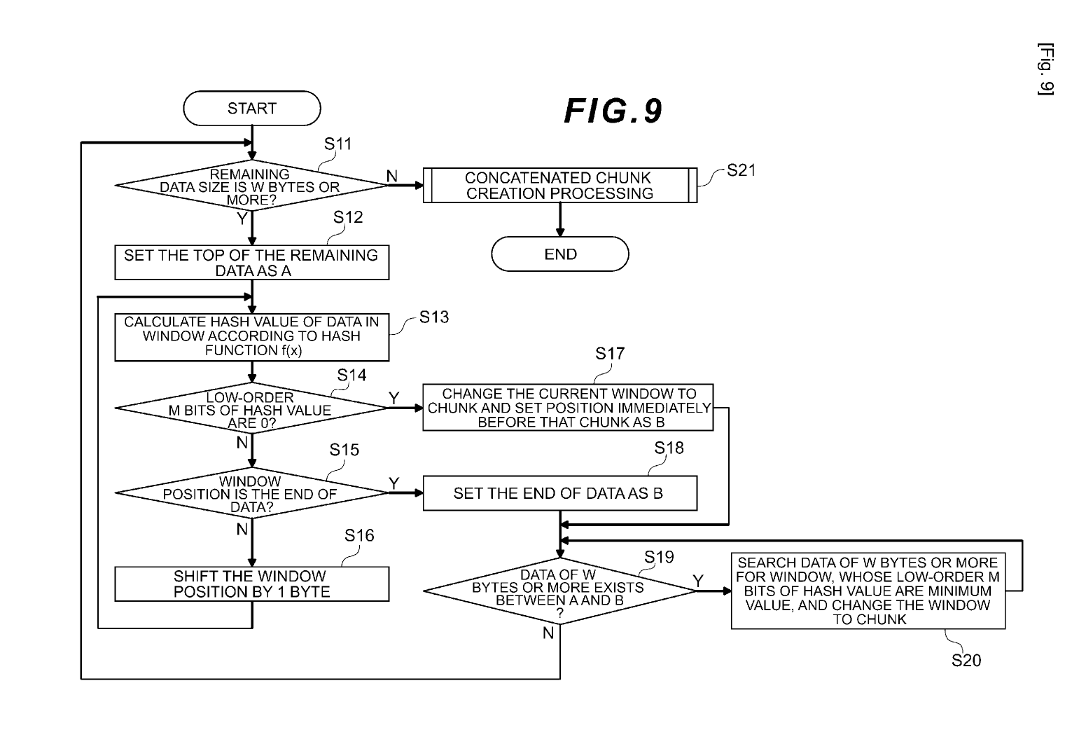

Next, data division processing will be explained with reference to a flowchart in FIG. 9.

This processing is executed by the CPU 26.

When receiving, for example, a write access as an access request from the client 10, the CPU 26 sequentially sets windows, which are search areas, as parameters to, for example, the data block 100 from its top A to its end from among data blocks attached to the write access. When this happens, a window of a fixed size, for example, W bytes is used as each window and is set at a position including an area where the adjacent windows would overlap each other.

Firstly, if a window 501 is set from the top A of the data block 100, the CPU 26 judges whether or not the size of remaining data in the size of data existing in the data block 100 is W bytes or more (S11).

If an affirmative judgment result is obtained in step S11, that is, if an area equal to or larger than the fixed size of the window 501 exists in the data block 100, the CPU 26 sets the top of the remaining data, for example, the top of the data block 100 as A (S12) and calculates a hash value of data in the window 501 by using the hash function f(x) (S13).

Next, the CPU 26 judges whether or not a value represented by the low-order M bits of the calculated hash value is the first set value, for example, 0 (S14).

If a negative judgment result is obtained in step S14, the CPU 26 judges whether or not the position of the window 501 is at the end of the data, that is, the end of the data block 100 (S15). If a negative judgment result is obtained in step S15, for example, if the position of the window 501 is not at the end of the data, the CPU 26 shifts the position of the window 501 by 1 byte (S16), newly sets a window 502 of the fixed size to the data block 100, returns to the processing in step S13, calculates a hash value of data in the window 502 by using the hash function f(x), and repeats the processing of step S14 and step S15.

On the other hand, if an affirmative judgment result is obtained in step S14, the CPU 26 allocates the current window, for example, a window 511 to a chunk (first chunk), sets a position immediately before this chunk 511 as data end B (S17), and proceeds to step S19.

If an affirmative judgment result is obtained in step S15, for example, if the CPU 26 determines that the position of the window 502 is at the end of the data, the CPU 26 sets the data end as B (S18) and proceeds to processing in step S19.

Next, the CPU 26 judges whether or not data of W bytes or more exists in an area between the top A and the data end B (S19).

If an affirmative judgment result is obtained in step S19, the CPU 26 searches the data of W bytes or more (data in the set windows) for a window for which a value represented by low-order M bits of a hash value is a second set value, for example, a minimum value, allocates this window, for example, a window 504 to a chunk (second chunk) (S20), and returns to the processing of step S19.

On the other hand, if a negative judgment result is obtained in step S19, this means that data less than W bytes exists between A and B, so that the CPU 26 returns to the processing of step S11.

If a negative judgment result is obtained in step S11, that is, if data less than W bytes exists between A and B or the size of the remaining data is less than W bytes, the CPU 26 executes concatenated chunk creation processing for allocating the data less than W bytes to a concatenated chunk (S21) and then terminates the processing in this routine.

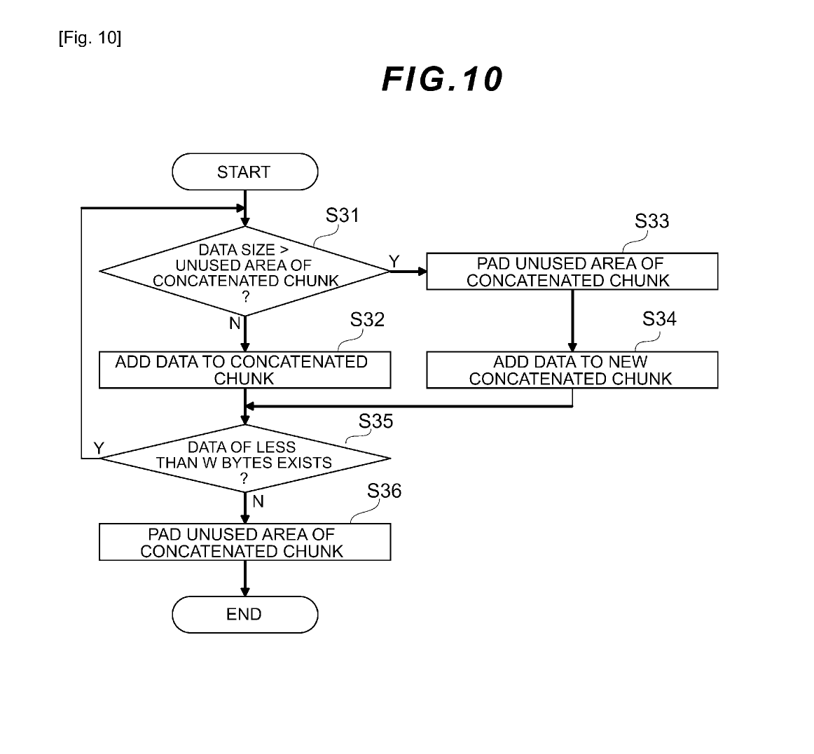

Next, the content of the concatenated chunk creation processing will be explained with reference to a flowchart in FIG. 10.

This processing is the specific content of step S21 in FIG. 9 and is executed by the CPU 26.

The CPU 26 judges whether or not the size of the data remaining as a processing target is larger than an unused area of the concatenated chunk (S31).

If a negative judgment result is obtained in step S31, that is, if the size of the data remaining as the processing target is less than the unused area of the concatenated chunk, the CPU 26 adds the data remaining as the processing target to the concatenated chunk, for example, a concatenated chunk 106 (S32) and proceeds to processing of step S35.

On the other hand, if an affirmative judgment result is obtained in step S31, that is, if the size of the data remaining as the processing target is larger than the unused area of the concatenated chunk, the CPU 26 embeds the data 0 as padding data in the unused area of the concatenated chunk, to which the data less than W bytes was added in step S32, (S33) and configures this concatenated chunk as a concatenated chunk without any unused area.

Next, the CPU 26 creates a new concatenated chunk to process the data less than W bytes, which remains as the processing target, adds the data less than W bytes remaining as the processing target to the newly created concatenated chunk (S34), and proceeds to processing of step S35.

Subsequently, in step S35, the CPU 26 judges whether or not the data remaining as the processing target is less than W bytes. If an affirmative judgment result is obtained in step S35, the CPU 26 returns to the processing of step S31 and repeats the processing from step S31 to S35.

If a negative judgment result is obtained in step S35, that is, if data less than W bytes does not exist, the CPU 26 embeds the padding data in the unused area of the concatenated chunk, configures this concatenated chunk as a concatenated chunk without any unused area (S36), and then terminates the processing in this routine.

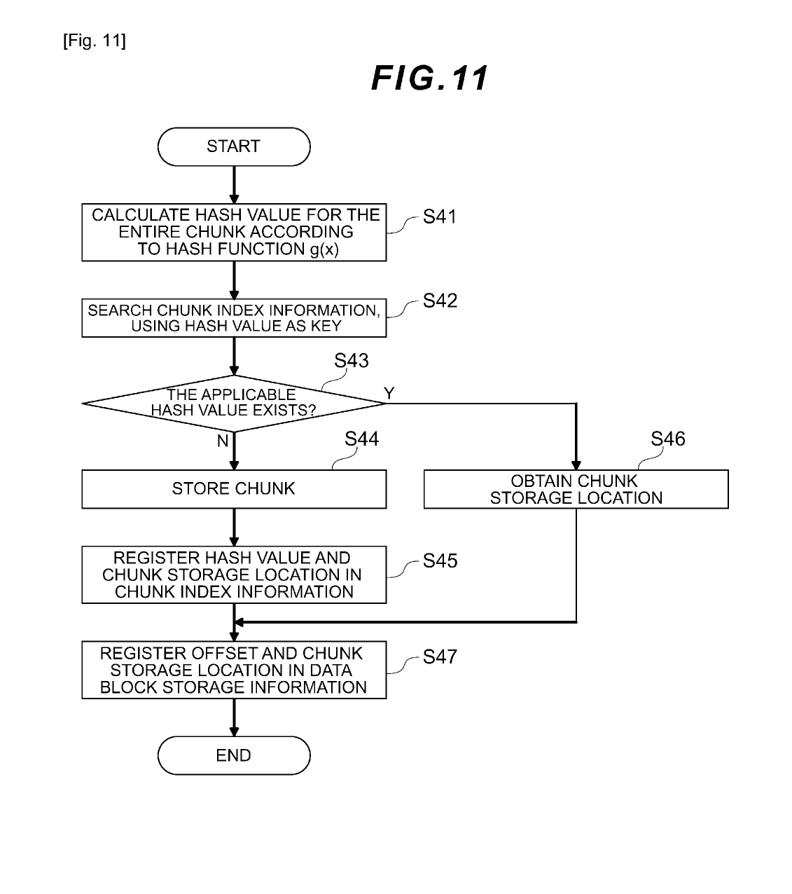

Next, the de-duplication processing will be explained with reference to a flowchart in FIG. 11.

This processing is started by the CPU 26 activating the de-duplication program 30.

If each data block is divided into a plurality of chunks with respect to the data block of each generation in the process of processing the data blocks of a plurality of generations, the CPU 26 calculates a hash value of the entire chunk with respect to each chunk, for example, the first chunk, the second chunk, and the concatenated chunk by using the hash function g(x) (S41).

Next, the CPU 26 searches the chunk index information 36, using the hash value obtained by calculation as a key (S42), and then judges whether or not the relevant hash value, that is, the same hash value as that obtained by calculation exists as the hash value 36A in the chunk index information 36 (S43).

If a negative judgment result is obtained in step S43, the CPU 26 stores a chunk corresponding to the hash value 36A obtained by calculation, in the chunk storage area 40 (S44), associates the hash value 36A with the chunk storage location 36B, and registers them in the chunk index information 36 (S45).

On the other hand, if an affirmative judgment result is obtained in step S43, that is, if the same hash value 36A as the hash value obtained by calculation exists in the chunk index information 36, the CPU 26 obtains the chunk storage location 36B from the chunk index information 36 (S46) and proceeds to processing of step S47.

Next, in step S47, the CPU 26 refers to the data block storage information 34B based on information registered in the chunk index information 36, registers the offset 34D of each chunk and also the chunk storage location 36B of each chunk as the chunk storage location 34E in the data block storage information 34B, and then terminates the processing in this routine.

If a negative judgment result is obtained in step S43 in the process of executing this de-duplication processing, this means that the same hash value does not exist in the chunk index information 36, so that the CPU 26 manages the relevant chunk as a chunk which is not the target of the de-duplication.

On the other hand, if an affirmative judgment result is obtained in step S43, this means that the same hash value exists for the relevant chunk, so that the CPU 26 manages the relevant chunk as a chunk which is the target of the de-duplication.

If the data block 200, 300 of each generation is divided into a plurality of chunks as shown in FIG. 3 in the process of processing data blocks of a plurality of generations, for example, the data blocks 200, 300, a hash value of each chunk is calculated by using the hash function g(x).

For example, if “a,” “b,” “c,” “d,” “e” are obtained by calculation as hash values of the concatenated chunk 212, the first chunk 210, the second chunk 216, the first chunk 214, and the concatenated chunk 218, respectively, these hash values are recorded in the management table T1.

Furthermore, “f,” “b,” “g,” “d,” “e” are obtained by calculation as hash values of the concatenated chunk 312, the first chunk 310, the second chunk 316, the first chunk 314, and the concatenated chunk 318, respectively, and these hash values are recorded in the management table T2.

Subsequently, the concatenated chunk 212, the first chunk 210, the second chunk 216, the first chunk 214, and the concatenated chunk 218 are stored, as chunks obtained by dividing the data block 200, in each chunk storage area 40 of the storage device 20.

Meanwhile, when storing each chunk of the data block 300 in the storage device, the hash values of the respective chunks of the data block 200 are compared with the hash values of the respective chunks of the data block 300 and processing for managing the chunks corresponding to the same hash value as de-duplication targets is executed.

For example, the hash values (“b,” “d,” “e”) relating to the first chunks 310, 314 and the concatenated chunk 318 of the data block 300 are the same as the hash values (“b,” “d,” “e”) relating to the first chunks 210, 214 and the concatenated chunk 218 of the data block 200, so that the first chunks 310, 314, and the concatenated chunk 318 are managed as the de-duplication targets.

As a result, the first chunks 310, 314 and the concatenated chunk 318 of the data block 300 are not stored in the chunk storage area 40 of the storage device 20 and the second chunk 316 and the concatenated chunk 312 are recorded, as update target chunks, in the chunk storage area 40 of the storage device 20.

According to this embodiment, the de-duplication effect can be enhanced even if the data blocks 200, 300 are divided by the fixed-length (4 bytes) windows into a plurality of chunks and each chunk obtained by division is managed by using a hash value obtained from fixed-length data.

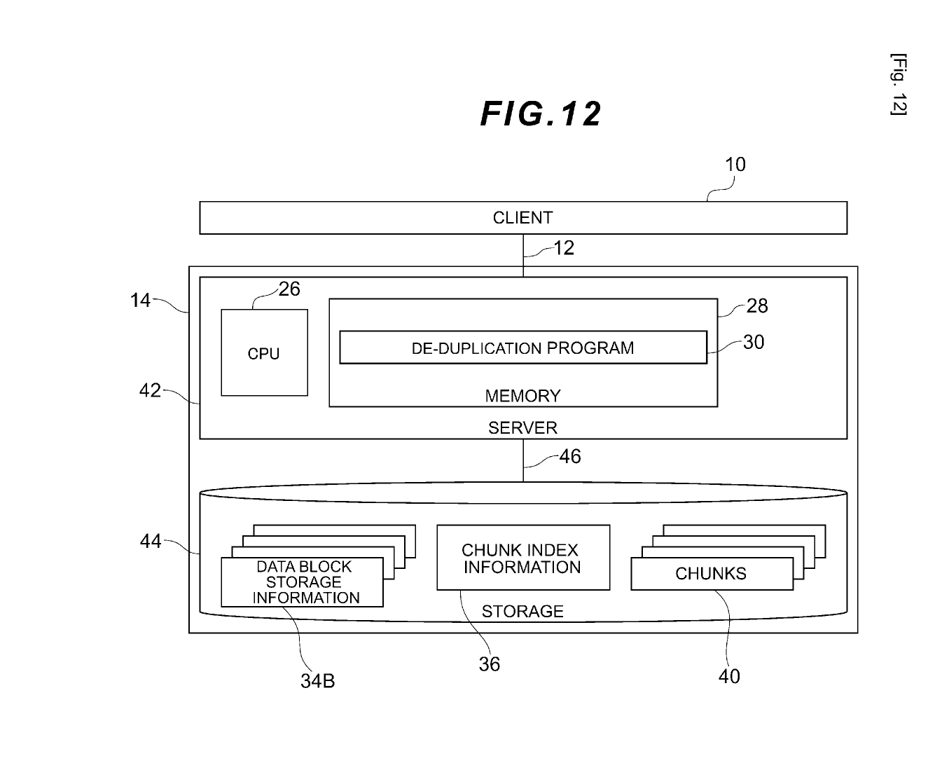

Next, FIG. 12 shows a block diagram of a computer system according to the second embodiment of the present invention.

Referring to FIG. 12, the storage system 14 is constituted from a server 42 and a storage device 44 and the server 42 is connected via the network 12 to the client 10 and via an internal network 46 to the storage device 44.

This embodiment is configured in the same manner as the first embodiment, except that the server 42 is configured as a file server and the storage device 44 is configured as file storage. Under this circumstance, the server 42 serves as a controller for controlling data input to, or output from, the storage device 44.

The server 42 is constituted from the CPU 26 serving as a processing for supervising and controlling the entire server 42, and the memory 28. The memory 28 stores various programs such as the de-duplication program 30 for executing chunk de-duplication processing.

The storage device 44 is composed of a plurality of storage units such as HDDs (Hard Disk Drives). The data block storage information 34B and the chunk index information 36 are stored and the chunk storage area 40 for storing chunks are formed in the storage area composed of one or more storage units. Furthermore, one or more file systems are configured in the storage area composed of one or more storage units.

Under this circumstance, the file system is configured, for example, as a file system having file groups and directory groups hierarchized and configured in the storage area composed of one or more storage units, and each file can be configured as a data block.

Furthermore, a plurality of file systems can be integrated, the integrated file system can be configured as a hierarchized file system which is virtually hierarchized, and the hierarchized file system can be provided as an access target from the server 42 to the client 10.

If each file group of the file system is configured as a data block according to this embodiment and when each file is managed, each file can be divided by fixed-length windows into a plurality of chunks and each chunk can be managed by using a hash value obtained from fixed-length data.

When managing each file according to this embodiment, the de-duplication effect can be enhanced even if each file is divided by the fixed-length windows into a plurality of chunks and each chunk is managed by using the hash value obtained from the fixed-length data.

When consideration is given to prioritize a calculation speed over accuracy regarding the hash function f(x) used to divide a data block into a plurality of chunks according to each of the aforementioned embodiments and, for example, the window is composed of 8 kilobytes, a function appropriate to calculate a 32-bit or 64-bit hash value from 8-KB data can be used as the hash function f(x).

On the other hand, when consideration is given to prioritize accuracy over the calculation speed regarding the hash function g(x) used to calculate a hash value used for the de-duplication of each chunk and, for example, the window is composed of 8 kilobytes, a function appropriate to calculate a 256-bit or 512-bit hash value from 8-KB data can be used as the hash function g(x).

Furthermore, a value which is not 0 and is larger than 0 can be used as the first set value. In this case, a window for which the first hash value is equal to or less than the first set value can be allocated to the first chunk.

Furthermore, a value larger than the first set value can be used as the second set value. In this case, a window for which the first hash value is equal to or less than the second set value larger than the first set value can be allocated to the second chunk. Furthermore, a maximum value among a plurality of first hash values can be also used as the second set value.

Incidentally, the present invention is not limited to the aforementioned embodiments, and includes various variations. For example, the aforementioned embodiments have been described in detail in order to explain the invention in an easily comprehensible manner and are not necessarily limited to those having all the configurations explained above. Furthermore, part of the configuration of a certain embodiment can be replaced with the configuration of another embodiment and the configuration of another embodiment can be added to the configuration of a certain embodiment. Also, part of the configuration of each embodiment can be deleted, or added to, or replaced with, the configuration of another configuration.

Furthermore, part or all of the aforementioned configurations, functions, and so on may be realized by hardware by, for example, designing them in integrated circuits. Also, each of the aforementioned configurations, functions, and so on may be realized by software by processors interpreting and executing programs for realizing each of the functions. Information such as programs, tables, and files for realizing each of the functions may be recorded and retained in memories, storage devices such as hard disks and SSDs (Solid State Drives), or storage media such as IC (Integrated Circuit) cards, SD (Secure Digital) memory cards, and DVDs (Digital Versatile Discs).

### REFERENCE SIGNS LIST

10 Client (client terminal)

12 Network

14 Storage system

16 Controller

18, 20 Storage devices

22, 24 Internal networks

26 CPU

28 Memory

30 De-duplication program

34 Virtual volume information

36 Chunk index information

38 Storage pool

40 Chunk storage area

42 Server

44 Storage device

46 Internal network

100 Data block

501 to 511 Windows

102 First chunk

104 Second chunk

106 Concatenated chunk

1. A storage system comprising a storage device having one or more storage units, and a controller for controlling data input to, or output from, the storage device based on an access request from an access requestor,
wherein in a process of sequentially processing data blocks composed of a plurality of pieces of data on the basis of the access request, the controller: sequentially sets a search area of a fixed size from a top of each data block to an end thereof; calculates a first hash value of each search area from data of each set search area; allocates one or more search areas, for which the calculated first hash value becomes a first set value, as a first chunk from among each set search area; allocates one or more search areas, for which the calculated first hash value becomes a second set value, as a second chunk from among the search areas existing in an area larger than the search area if the area larger than the search area exists in an area other than an area in the data block to which the search area is allocated and to which the first chunk is allocated; allocates one or more areas smaller than the search area as a third chunk if one or more areas smaller than the search area exist in an area other than an area in the data block to which the search area is allocated, and to which the first chunk or the second chunk is allocated; calculates a second hash value of each allocated chunk from data of each allocated chunk; compares the second hash value of each allocated chunk between the data blocks; and manages the chunks having the same second hash value, as de-duplication chunks from among the chunks allocated to each data block if the chunks having the same second hash value are allocated to each data block.

2. The storage system according to claim 1, wherein the controller sets low-order M bits (M is a positive integer), each of which is 0, of the first hash value, as the first set value; and if the low-order M bits of the first hash value are a plurality of values larger than 0, the controller sets a minimum value among the values of the low-order M bits of the first hash value, as the second set value.

3. The storage system according to claim 1, wherein the controller stores a chunk which is allocated to one data block, from among a plurality of chunks managed as the de-duplication chunks, in the storage device; and excludes chunk storage processing for storing a chunk, which is allocated to the other data block, in the storage device.

4. The storage system according to claim 1, wherein the controller allocates one or more search areas, for which the calculated first hash value is equal to or less than the first set value, as the first chunk and allocates one or more search areas, for which the calculated first hash value is equal to or less than the second set value larger than the first set value, as the second chunk.

5. The storage system according to claim 1, wherein if an unused area, other than the area smaller than the search area, exists in the third chunk, the controller allocates padding data for filling the unused area to the unused area and calculates the second hash value of the third chunk, to which the padding data is allocated, by assigning data of the area smaller than the search area and the allocated padding data to a hash function.

6. The storage system according to claim 1, wherein if the third chunk is configured by allocating a plurality of areas smaller than the search area, the controller calculates the second hash value of the third chunk, to which the plurality of areas smaller than the search area are allocated, by assigning data of the plurality of areas smaller than the search area to a hash function.

7. The storage system according to claim 1, wherein if the search area is sequentially set to each data block, the controller sets each search area at a position including an area where the adjacent search areas would overlap each other.

8. A data processing method for a storage system comprising a storage device having one or more storage units, and a controller for controlling data input to, or output from, the storage device based on an access request from an access requestor,
the data processing method comprising, in a process of sequentially processing data blocks composed of a plurality of pieces of data on the basis of the access request:
a step executed by the controller of sequentially setting a search area of a fixed size from a top of each data block to an end thereof;
a step executed by the controller of calculating a first hash value of each search area from data of each set search area;
a step executed by the controller of allocating one or more search areas, for which the calculated first hash value becomes a first set value, as a first chunk from among each set search area;
a step executed by the controller of allocating one or more search areas, for which the calculated first hash value becomes a second set value, as a second chunk from among the search areas existing in an area larger than the search area if the area larger than the search area exists in an area other than an area in the data block to which the search area is allocated and to which the first chunk is allocated;
a step executed by the controller of allocating one or more areas smaller than the search area as a third chunk if one or more areas smaller than the search area exist in an area other than an area in the data block to which the search area is allocated and to which the first chunk or the second chunk is allocated;
a step executed by the controller of calculating a second hash value of each allocated chunk from data of each allocated chunk; and
a step executed by the controller of comparing the second hash value of each allocated chunk between the data blocks and managing the chunks having the same second hash value, as de-duplication chunks from among the chunks allocated to each data block if the chunks having the same second hash value are allocated to each data block.

9. The data processing method for the storage system according to claim 8, further comprising:
a step executed by the controller of storing a chunk which is allocated to one data block, from among a plurality of chunks managed as the de-duplication chunks, in the storage device; and
a step executed by the controller of excluding chunk storage processing for storing a chunk which is allocated to the other data block, from among a plurality of chunks managed as the de-duplication chunks, in the storage device.

10. The data processing method for the storage system according to claim 8, further comprising:
a step executed by the controller of allocating one or more search areas, for which the calculated first hash value is equal to or less than the first set value, as the first chunk; and
a step executed by the controller of allocating one or more search areas, for which the calculated first hash value is equal to or less than the second set value larger than the first set value, as the second chunk.

11. The data processing method for the storage system according to claim 8, further comprising:
a step executed by the controller of, if an unused area, other than the area smaller than the search area, exists in the third chunk, allocating padding data for filling the unused area to the unused area; and
a step executed by the controller of calculating the second hash value of the third chunk, to which the padding data is allocated, by assigning data of the area smaller than the search area and the allocated padding data to a hash function.

12. The data processing method for the storage system according to claim 8, further comprising a step executed by the controller of, if the third chunk is configured by allocating a plurality of areas smaller than the search area, calculating the second hash value of the third chunk, to which the plurality of areas smaller than the search area are allocated, by assigning data of the plurality of areas smaller than the search area to a hash function.

13. The data processing method for the storage system according to claim 8, further comprising a step executed by the controller of, if the search area is sequentially set to each data block, setting each search area at a position including an area where the adjacent search areas would overlap each other.
